(19) United States
(12) Patent Application Publication
(10) Pub. No.: US 2025/0042219 A1
(43) Pub. Date: Feb. 6, 2025

(54) WORK MACHINE

(71) Applicant: KOMATSU LTD., Tokyo (JP)

(72) Inventors: Yuki TAKASE, Tokyo (JP); Ayumi OHKUMA, Tokyo (JP); Yutaka TANAKA, Tokyo (JP); Masaki DAIMON, Tokyo (JP); Yuya HIROSE, Tokyo (JP)

(21) Appl. No.: 18/717,797

(22) PCT Filed: Dec. 16, 2022
(86) PCT No.: PCT/JP2022/046426

§ 371 Date: Jun. 7, 2024

(30) Foreign Application Priority Data
Jan. 27, 2022 (JP) 2022-011245

(51) Int. Cl. B60H 1/00

(52) U.S. Cl. CPC B60H 1/00278; B60H 1/00392; B60Y 2200/412

(57) ABSTRACT

A work machine actuates a work implement with power from a battery device. The work machine includes a first region in which the battery device is disposed, a second region in which a battery thermal management system is disposed, and a vehicle body cover having a polyhedral shape and surrounding the first region and the second region. The battery thermal management system manages temperature of the battery device. In the vehicle body cover, an orientation of a surface in which a first air intake port arranged to guide air into the first region is formed, is different from an orientation of a surface in which a second exhaust port arranged to draw air out from the second region is formed.

### CROSS-REFERENCE TO RELATED APPLICATIONS

This application is a U.S. National stage application of International Application No. PCT/JP2022/046426, filed on Dec. 16, 2022. This U.S. National stage application claims priority under 35 U.S.C. § 119(a) to Japanese Patent Application No. 2022-011245, filed in Japan on Jan. 27, 2022, the entire contents of which are hereby incorporated herein by reference.

### BACKGROUND

### Technical Field

The present disclosure relates to a work machine.

### Background Art

Japanese Patent Laid-open No. 2012-202065 discloses an electric shovel as an example of a work machine. The electric shovel comprises an electric motor driven by electric power stored in a battery device instead of an engine that is conventionally provided to a hydraulic excavator. The electric motor drives a hydraulic pump for supplying pressure oil to hydraulic cylinders for a work implement.

### SUMMARY

When suppressing the deterioration of the batteries contained in the battery device due to temperature, there is a need to maintain the batteries in a suitable temperature range (for example, 20° C. to 35° C.).

Accordingly, it is possible to control the temperature of the batteries with a battery thermal management system (BTMS) that cools or heats a heating medium liquid that flows through a heat medium liquid path inside the battery device.

However, the load for controlling the temperature of the battery device by means of the BTMS becomes too large when exhaust from the BTMS is discharged to the battery device because the BTMS itself also performs heat exchange when cooling the heat medium liquid.

An object of the present disclosure is to provide a work machine with which it is possible to reduce the load for controlling the temperature of a battery device.

A work machine according to a first embodiment of the present disclosure comprises a first region in which a battery device is disposed, a second region in which a battery thermal management system for managing the temperature of the battery device is disposed, and a vehicle body cover having a polyhedral shape that surrounds the first region and the second region. In the vehicle body cover, an orientation of the surface in which a first air intake port for guiding air into the first region is formed, is different from an orientation of an surface in which a second exhaust port for drawing out air from the second region is formed.

The work implement according to a second embodiment of the present disclosure is related to the first embodiment, wherein, in the vehicle body cover, the orientation of the surface in which a first exhaust port for drawing out air from the first region is formed, is different from the orientation of the surface in which a second air intake port for guiding air into the second region is formed.

The work implement according to a third embodiment of the present disclosure is related to the first or second embodiment, wherein, in the vehicle body cover, the surface in which the first air intake port is formed is positioned on the opposite side from the surface in which the second exhaust port is formed.

The work machine according to a fourth embodiment of the present disclosure is related to any one of the first to third embodiments, wherein a cooling unit for cooling at least one of hydraulic fluid to be supplied to the work implement and refrigerant to be supplied to an air-conditioning device is disposed in the first region, and the cooling unit is disposed downstream of the battery device in the direction that air in the first region flows.

The work machine according to a fifth embodiment of the present disclosure is related to any one of the first to fourth embodiments and further comprises a cab disposed in front of the vehicle body cover. The surface in which the second exhaust port is formed is a front surface of the vehicle body cover, and at least a portion of the second exhaust port is spaced away from the cab as seen in a front view.

The work machine according to a sixth embodiment of the present disclosure is related to any one of the first to fifth embodiments and further comprises an electric motor that drives with power from the battery device, a third region in which a hydraulic pump driven by the electric motor is disposed, and a first partition plate that partitions the first region and the third region.

The work machine according to a seventh embodiment of the present disclosure is related to any one of the first to sixth embodiments and further comprises a second partition plate that partitions the first region and the second region.

The work machine according to an eighth embodiment of the present disclosure is related to any one of the first to seventh embodiments and further comprises a rectifying member. The battery thermal management system has a discharge port for discharging air and the rectifying member guides the air discharged from the discharge port of the battery thermal management system to the second exhaust port of the vehicle body cover.

According to the present disclosure, there can be provided a work machine with which it is possible to reduce the load for controlling the temperature of a battery device.

### BRIEF DESCRIPTION OF THE DRAWINGS

FIG. 1 is a perspective view of an electric shovel according to an embodiment.

FIG. 2 is a perspective view of the electric shovel according to an embodiment.

FIG. 3 is a front view of the electric shovel according to an embodiment.

FIG. 4 is a cross-sectional view illustrating the air flow inside a first region according to an embodiment.

FIG. 5 is a cross-sectional view illustrating the air flow inside a second region according to an embodiment.

FIG. 6 is a schematic view of a configuration of the inside of the second region according to modified example 7.

FIG. 7 is a perspective view of a rectifying member according to modified example 7.

### DETAILED DESCRIPTION OF EMBODIMENT(S)

### (Electric Shovel)

A configuration of an electric shovel 1 (example of a “work machine”) according to the present embodiment is explained with reference to the drawings.

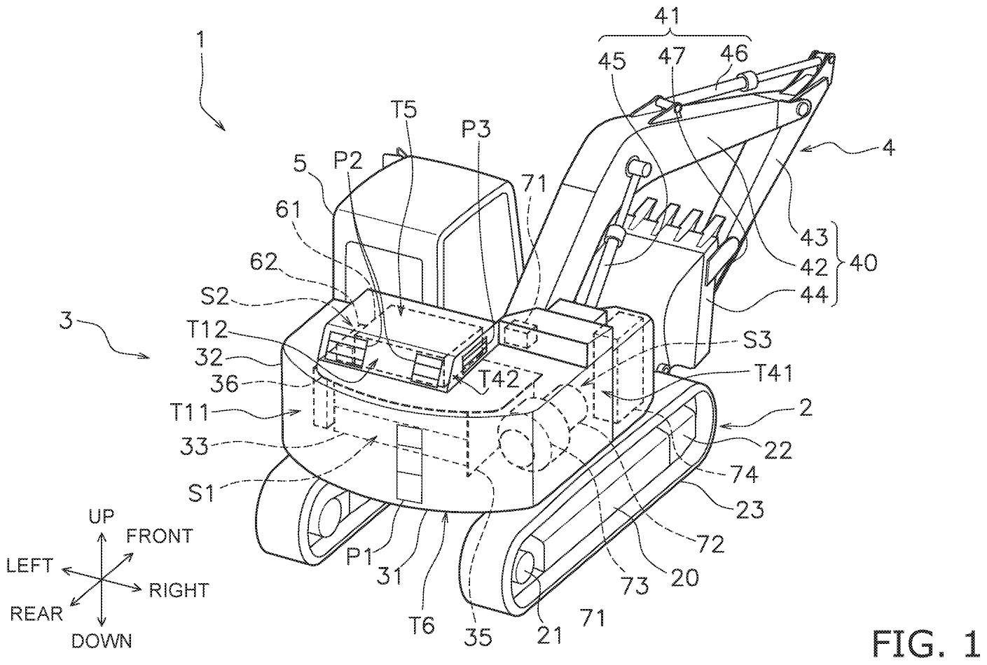

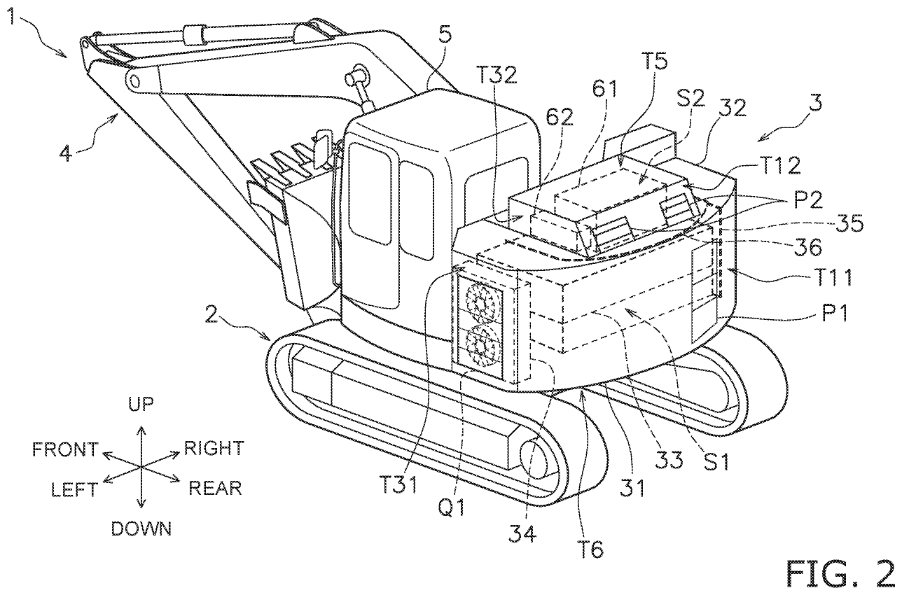

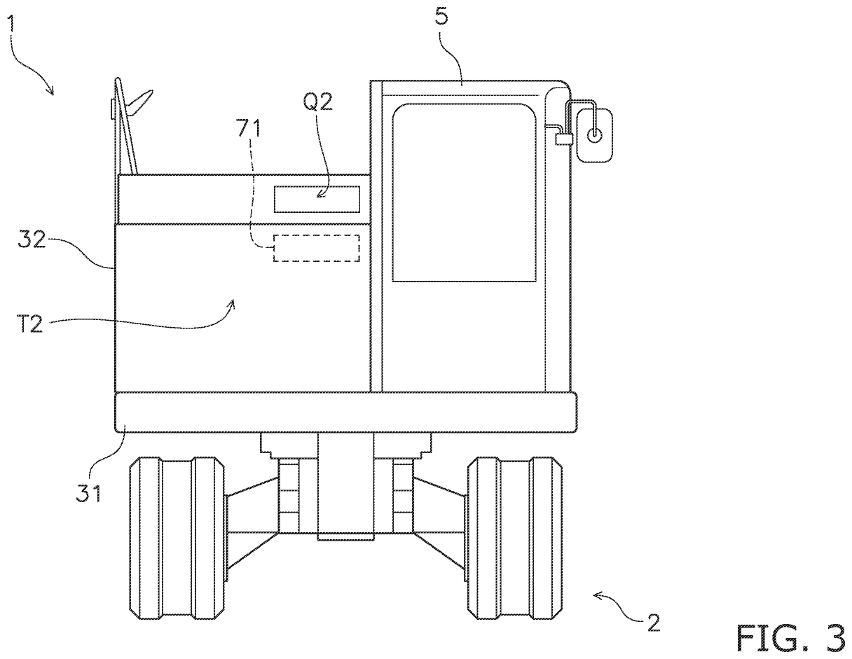

FIG. 1 is a perspective view of the electric shovel 1 from behind and to the right. FIG. 2 is a perspective view of the electric shovel 1 from behind and to the left. FIG. 3 is a front view of the electric shovel 1.

In the present description, “up” and “down” respectively signify upward and downward in the vertical direction. Similarly, “front” and “rear” respectively signify forward and rearward in the front-back direction of the electric shovel 1, and “left” and “right” respectively signify leftward and rightward when looking toward the front of the electric shovel 1.

As illustrated in FIG. 1, the electric shovel 1 comprises an undercarriage 2, a rotating super structure 3, a work implement unit 4, and a cab 5.

The undercarriage 2 includes track frames 20, drive wheels 21, driven wheels 22, and crawler belts 23. The track frames 20 extend in the front-back direction. The drive wheels 21 are supported at rear end parts of the track frames 20. The driven wheels 22 are supported at front end parts of the track frames 20. The crawler belts 23 are stretched across the drive wheels 21 and the driven wheels 22.

The rotating super structure 3 is disposed above the undercarriage 2. The rotating super structure 3 is provided in a rotatable manner with respect to the undercarriage 2. The rotating super structure 3 has a rotating frame 31 (example of a “vehicle body frame”) and a vehicle body cover 32.

The rotating frame 31 is disposed above the undercarriage 2. The rotating frame 31 is supported by the undercarriage 2.

The vehicle body cover 32 covers a space above the rotating frame 31. The vehicle body cover 32 is formed in a polyhedral shape. In FIGS. 1 and 2, the vehicle body cover 32 is depicted as transparent so as to be able to see the inside thereof. The vehicle body cover 32 surrounds a first region S1, a second region S2, and a third region S3.

A battery device 33 and a cooling unit 34 are disposed in the first region S1.

The battery device 33 is disposed in a rear upper end part of the rotating frame 31. The battery device 33 includes a plurality of battery packs that are stacked in the up-down direction, and a water jacket in which a heat medium liquid circulates. A plurality of batteries are aligned inside each battery pack. The batteries are maintained in a suitable temperature range (for example, 20° C. to 35° C.) by the heat medium liquid circulating through the inside of the water jacket. The battery device 33 also functions as a counterweight that is provided to a conventional hydraulic excavator.

The cooling unit 34 is disposed at a left end part of the rotating frame 31. The cooling unit 34 has a hydraulic fluid cooling device and a refrigerant cooling device. The hydraulic fluid cooling device cools the hydraulic fluid to be supplied to the belowmentioned work implement driving unit 41. The hydraulic fluid cooling device includes an oil cooler that circulates the hydraulic fluid and a cooling fan for blowing air on the oil cooler. The hydraulic fluid that circulates through the inside of the oil cooler is cooled by the air blown by the cooling fan. The refrigerant cooling device cools a refrigerant to be supplied to the air-conditioning device disposed inside the cab 5. The refrigerant cooling device includes a condenser and a cooling fan for blowing air on the condenser. The refrigerant circulating through the inside of the condenser is cooled by the air blown by the cooling fan.

The first region S1 is partitioned from the third region S3 by a first partition plate 35. In this way, the transmission of waste heat from a heat generating component (for example, a belowmentioned electric motor 72 or a hydraulic pump 73) in the third region S3 can be suppressed by the placement of the first partition plate 35. The first partition plate 35 is formed as a plate. The shape of the first partition plate 35 is not limited in particular. The first partition plate 35 may not completely seal the space between the first region S1 and the third region S3 and the first region S1 and the third region S3 may be partially linked.

The first region S1 is partitioned from the second region S2 by a second partition plate 36. In this way, the transmission of waste heat from a heat generating component (for example, a belowmentioned BTMS 61) in the second region S2 can be suppressed by the placement of the second partition plate 36. The second partition plate 36 is formed as a plate. The shape of the second partition plate 36 is not limited in particular. The second partition plate 36 may not completely seal the space between the first region S1 and the second region S2 and the first region S1 and the second region S2 may be partially linked.

The second region S2 is provided above the first region S1. The battery thermal management system (BTMS, example of a battery thermal management system) 61 and a DC/DC converter 62 are disposed in the second region S2.

The BTMS 61 manages the temperature of the battery device 33. The BTMS 61 includes a chiller, a circulating pump, a compressor, a condenser, a blower, and a heater. The circulating pump sends the heat medium liquid cooled by the compressor, the condenser, and the blower, or sends the heat medium liquid heated by the heater, to the water jacket of the battery device 33. As a result, the batteries of the battery device 33 are maintained in the suitable temperature range (for example, 20° C. to 35° C.) and heat deterioration of the batteries is suppressed.

The DC/DC converter 62 steps down the voltage of the direct current power supplied from the battery device 33.

The third region S3 is provided to the right side of the first region S1 and the second region S2. An inverter 71, the electric motor 72, the hydraulic pump 73, and a control valve 74 are disposed in the third region S3.

The inverter 71 converts the direct current power supplied from the DC/DC converter 62 to an alternating current power of a desired frequency.

The electric motor 72 drives with the alternating current power supplied from the inverter 71. The electric motor 72 causes the undercarriage 2 and the work implement unit 4 to operate. Specifically, the electric motor 72 causes the undercarriage 2 and the work implement unit 4 to operate by driving the hydraulic pump 73 to supply pressure oil to the undercarriage 2 and the work implement unit 4. The hydraulic pump 73 supplies the pressure oil to the undercarriage 2 and the work implement unit 4 through the control valve 74.

The work implement unit 4 has a work implement 40 and a work implement driving unit 41. The work implement 40 has a boom 42, an arm 43, and a bucket 44. The work implement driving unit 41 includes a boom cylinder 45, an arm cylinder 46, and a bucket cylinder 47. The boom cylinder 45, the arm cylinder 46, and the bucket cylinder 47 operate by means of pressure oil supplied from the hydraulic pump 73.

The cab 5 is disposed on a front end part of the rotating frame 31. A seat for an operator to sit in and various operating levers for operating the undercarriage 2 and the work implement unit 4, etc., are disposed inside the cab 5.

### (Vehicle Body Cover 32)

As illustrated in FIG. 1-3, the vehicle body cover 32 is formed in a polyhedral shape. The vehicle body cover 32 has a plurality of outer surfaces. Specifically, the vehicle body cover 32 has a first rear surface T11, a second rear surface T12, a front surface T2, a first left surface T31, a second left surface T32, a first right surface T41, a second right surface T42, an upper surface T5, and a lower surface T6. The surfaces are examples of the surfaces of the vehicle body cover 32. Each surface may be partially or completely curved or bent.

The first rear surface T11 and the second rear surface T12 are surfaces that face to the rear. The front surface T2 is a surface that faces to the front. The first left surface T31 and the second left surface T32 are surfaces that face to the left. The first right surface T41 and the second right surface T42 are surfaces that face to the right. The upper surface T5 is a surface that faces upward. The lower surface T6 is a surface that faces downward.

In the present description, the orientation of the surfaces signifies the orientation facing from the inside to the outside of the vehicle body cover.

The first rear surface T11 is positioned to the rear of the first region S1 and the third region S3. The first rear surface T11 links the respective rear end parts of the first left surface T31 and the first right surface T41. The second rear surface T12 is positioned to the rear of the second region S2. The second rear surface T12 is positioned above the first rear surface T11. The second rear surface T12 links the respective rear end parts of the second left surface T32 and the second right surface T42. The first rear surface T11 and the second rear surface T12 are positioned on the opposite side from the front surface T2. The front surface T2 links the respective front end parts of the first left surface T31, the first right surface T41, the second left surface T32, and the second right surface T42.

The first left surface T31 is positioned to the left of the first region S1. The second left surface T32 is positioned to the left of the second region S2. The second left surface T32 is positioned above the first left surface T31. The first right surface T41 is positioned to the right of the third region S3. The second right surface T42 is positioned to the right of the second region S2. The second right surface T42 is positioned above the first right surface T41.

The upper surface T5 links the respective upper end parts of the second rear surface T12, the front surface T2, the second left surface T32, and the second right surface T42. The upper surface T5 is positioned on the opposite side from the lower surface T6. The lower surface T6 links the respective lower end parts of the first rear surface T11, the front surface T2, the first left surface T31, and the first right surface T41.

As illustrated in FIGS. 1 and 2, a first air intake port P1 is formed in the first rear surface T11 for guiding air into the first region S1. The first air intake port P1 is open toward the rear. Outdoor air is drawn into the inside of the first region S1 from the first air intake port P1 due to the suction force of the cooling fan included in the abovementioned cooling unit 34. The outdoor air is drawn into the first region S1 from the rear.

As illustrated in FIGS. 1 and 2, a second air intake port P2 is formed in the second rear surface T12 for guiding air into the second region S2. The second air intake port P2 is open toward the rear. The outdoor air is drawn into the inside of the second region 2 from the second air intake port P2 due to the suction force of the blower included in the abovementioned BTMS 61. The outdoor air is drawn into the second region S2 from the rear.

As illustrated in FIG. 1, a third air intake port P3 is formed in the second right surface T42 for guiding air into the second region S2. The third air intake port P3 is open toward the right. The outdoor air is drawn into the inside of the second region 2 from the third air intake port P3 due to the suction force of the blower included in the abovementioned BTMS 61. The outdoor air is drawn into the second region S2 from the right.

As illustrated in FIG. 2, a first exhaust port Q1 is formed in the first left surface T31 for drawing out air from the first region S1. The first exhaust port Q1 is open toward the left. The air inside the first region S1 blown out from the cooling fan included in the abovementioned cooling unit 34 is discharged to the outside from the first exhaust port Q1. The air inside the first region S1 is discharged toward the left from the first exhaust port Q1.

As illustrated in FIG. 3, a second exhaust port Q2 is formed in the front surface T2 for drawing out air from the second region S2. The second exhaust port Q2 is open toward the front. The air inside the second region S2 blown from the blower of the abovementioned BTMS 61 is discharged to the outside from the second exhaust port Q2. The air inside the second region S2 is discharged toward the front from the second exhaust port Q2. As illustrated in FIG. 3, all of the second exhaust port Q2 is spaced away from the cab 5 in the front view of the vehicle body cover 32. That is, the second exhaust port Q2 does not overlap the cab 5 in the front view of the vehicle body cover 32.

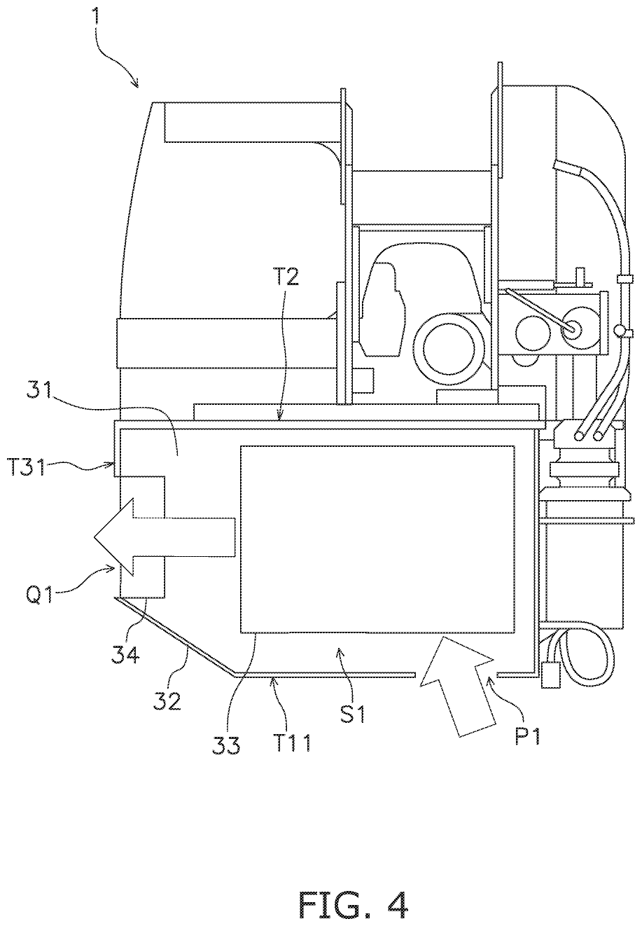

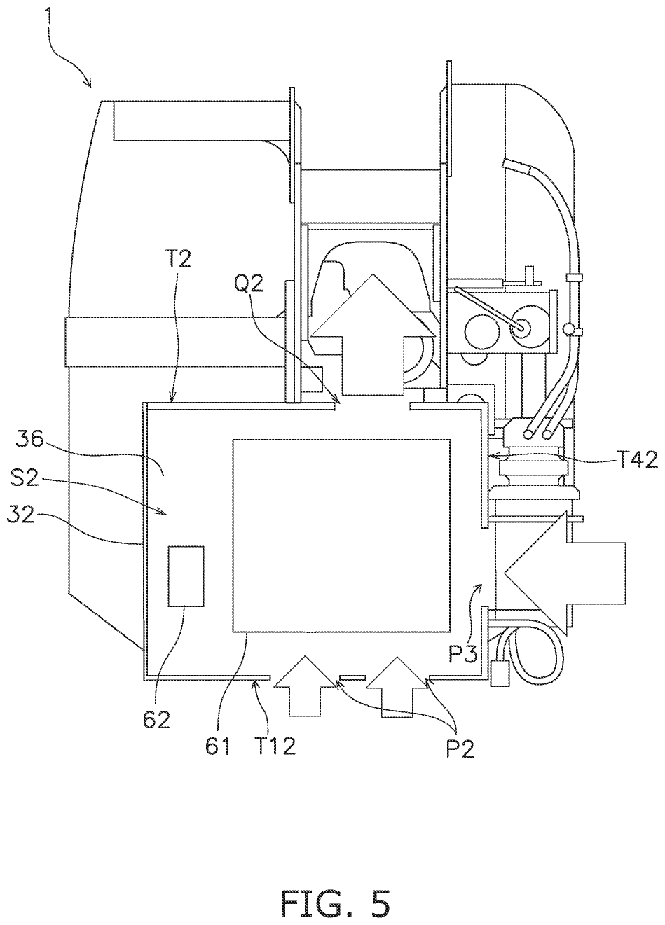

FIG. 4 is a cross-sectional view illustrating the air flow inside the first region S1 with arrows, and FIG. 5 is a cross-sectional view illustrating the air flow inside the first region S2 with arrows.

As illustrated in FIG. 4, the outdoor air drawn in from the first air intake port P1 formed on the first rear surface T11 to the first region S1 passes over the cooling unit 34 after having passed over the battery device 33, and is discharged from the first exhaust port Q1 formed on the first left surface T31.

As illustrated in FIG. 5, the outdoor air drawn into the second region S2 from the second air intake port P2 formed on the second rear surface T12 and the third air intake port P3 formed on the second right surface T42, is discharged to the outside from the second exhaust port Q2 formed on the front surface T2 after having passed over the BTMS 61.

In this way, the orientation of the first rear surface T11 in which the first air intake port P1 is formed and the orientation of the front surface T2 in which the second exhaust port Q2 is formed are different. The air inside the second region S2 is discharged toward the front and the outdoor air is drawn into the first region S1 from the rear. Accordingly, the warm air discharged from the second region S2 can be restricted from being drawn into the first region S1. As a result, the load for controlling the temperature of the battery device 33 by the BTMS 61 can be reduced because the heating of the battery device 33 can be suppressed.

In particular in the present embodiment, the first rear surface T11 in which the first air intake port P1 is formed is positioned on the opposite side from the front surface T2 in which the second exhaust port Q2 is formed, whereby the drawing in of the warm air discharged from the second region S2 into the first region S1 can be easily suppressed.

In addition, the orientation of the first left surface T31 in which the first exhaust port Q1 is formed differs from the orientation of the second rear surface T12 in which the second air intake port P2 is formed and differs from the orientation of the second right surface T42 in which the third air intake port P3 is formed. The air inside the first region S1 is discharged toward the left and the outdoor air is drawn into the second region S2 from the rear and from the right. Accordingly, the warm air discharged from the first region S1 can be restricted from being drawn into the second region S2. As a result, the load for controlling the temperature of the battery device 33 by the BTMS 61 can be reduced because the heating of the BTMS 61 can be suppressed.

As illustrated in FIG. 4, the cooling unit 34 is disposed downstream of the battery device 33 in the direction that the air inside the first region S1 flows. Therefore, when the outdoor air temperature is high, the air cooled by passing over the battery device 33 that is subjected to temperature management by the BTMS 61 can be supplied to the cooling unit 34 whereby the cooling efficiency for cooling the hydraulic fluid and the refrigerant in the cooling unit 34 can be improved. When the outdoor air temperature is low, the air heated by passing over the battery device 33 that is subjected to temperature management by the BTMS 61 can be supplied to the cooling unit 34 whereby over-cooling of the cooling unit 34 can be suppressed.

As illustrated in FIG. 3, the second exhaust port Q2 is spaced away from the cab 5 in the front view of the vehicle body cover 32. Therefore, heating of the cab 5 by the waste heat from the second region S2 can be suppressed,

### MODIFIED EXAMPLES OF THE EMBODIMENT

Although an embodiment of the present invention has been described herein, the present invention is not limited to the above embodiment and various modifications may be made within the scope of the invention.

### Modified Example 1

While the first air intake port P1 is formed in the first rear surface T11 and the second exhaust port Q2 is formed in the front surface T2 in the above embodiment, the present invention is not limited in this way. So long as the orientation of the surface in which the first air intake port P1 is formed and the orientation of the surface in which the second exhaust port Q2 is formed are different, the respective surfaces in which the first air intake port P1 and the second exhaust port Q2 are formed may be selected as desired from the plurality of surfaces of the vehicle body cover 32.

### Modified Example 2

While the first exhaust port Q1 is formed in the first left surface T31 and the second air intake port P2 is formed in the first rear surface T11 in the above embodiment, the present invention is not limited in this way. So long as the orientation of the surface in which the first exhaust port Q1 is formed and the orientation of the surface in which the second air intake port P2 is formed are different, the respective surfaces in which the first exhaust port Q1 and the second air intake port P2 are formed may be selected as desired from the plurality of surfaces of the vehicle body cover 32.

### Modified Example 3

While the second region S2 is provided above the first region S1 in the above embodiment, the second region S2 may also be provided below the first region S1.

### Modified Example 4

While all of the second exhaust port Q2 is spaced away from the cab 5 in the front view of the vehicle body cover 32 in the above embodiment, only a portion of the second exhaust port Q2 may be spaced away from the cab 5. If even a portion of the second exhaust port Q2 is spaced away from the cab 5, heating of the cab 5 can be suppressed.

### Modified Example 5

While the cooling unit 34 is configured to cool both the hydraulic fluid and the refrigerant in the above embodiment, the cooling unit 34 may also cool only one of the hydraulic fluid and the refrigerant.

### Modified Example 6

While an electric shovel has been used as an example of the work machine in the above embodiment, the work machine is not limited to an electric shovel. An electric wheel loader or motor grader may be exemplified as the work machine so long as the work machine is one in which the work implement is actuated with power from a battery device.

### Modified Example 7

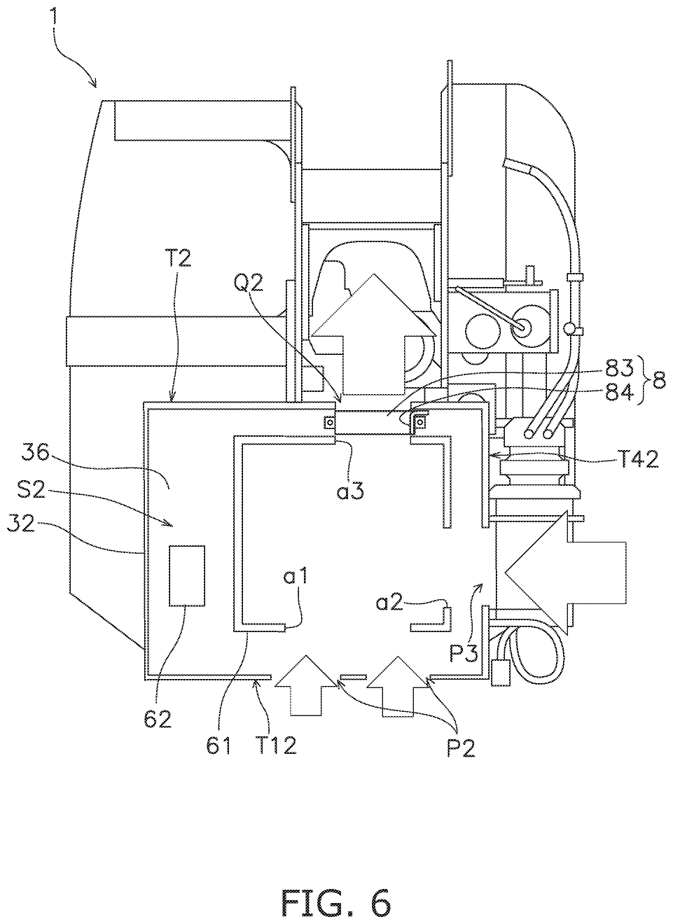

FIG. 6 is a schematic view of another configuration of the second region S2. The airflows in FIG. 6 are depicted with arrows.

As illustrated in FIG. 6, the BTMS 61 has a first air intake port a1, a second air intake port a2, and a discharge port a3. The air drawn into the second region S2 from the second air intake port P2 of the vehicle body cover 32 flows into the BTMS 61 from the first air intake port a1. The air drawn into the second region S2 from the third air intake port P3 of the vehicle body cover 32 flows into the BTMS 61 from the second air intake port a2. The air flowing into the BTMS 61 from the first air intake port a1 and the second air intake port a2 is discharged to the outside of the BTMS 61 through the discharge port a3. The air discharged from the discharge port a3 is discharged to the outside of the vehicle body cover 32 through the second exhaust port Q2 of the vehicle body cover 32.

As illustrated in FIG. 6, the electric shovel 1 may also be provided with a rectifying member 8 that is disposed between the discharge port a3 of the BTMS 61 and the second exhaust port Q2 of the vehicle body cover 32. The rectifying member 8 guides the air discharged from the discharge port a3 of the BTMS 61 to the second exhaust port Q2 of the vehicle body cover 32.

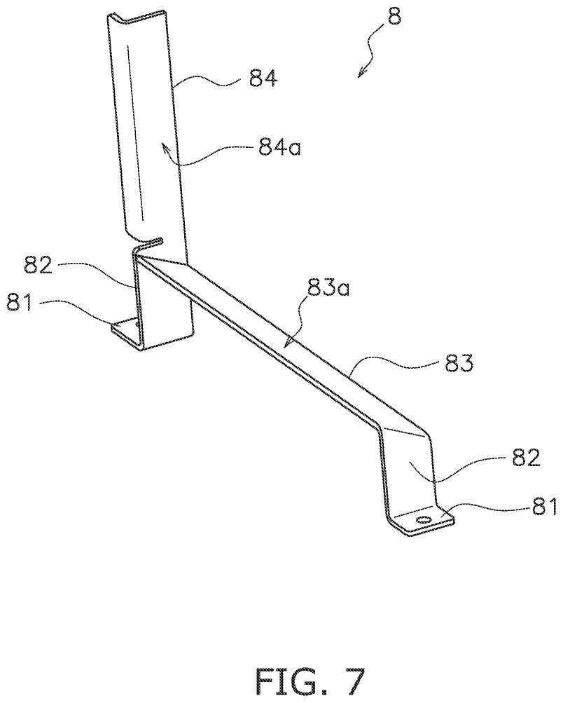

FIG. 7 is a perspective view of the rectifying member 8. The rectifying member 8 includes a pair of fixing parts 81, a pair of leg parts 82, a first rectifying plate 83, and a second rectifying plate 84.

The pair of fixing parts 81 are fixed to the second partition plate 36 by unillustrated bolts. The pair of leg parts 82 are provided standing erect from the pair of fixing parts 81.

The first rectifying plate 83 is supported by the pair of leg parts 82. The first rectifying plate 83 is formed as a plate. The first rectifying plate 83 has a first rectifying surface 83a. The first rectifying surface 83a is slanted upward. While the first rectifying surface 83a is slanted with respect to the horizontal direction in FIG. 7, the inclination angle of the first rectifying surface 83a may be changed as appropriate in accordance with the vertical positions of the respective lower sides of the discharge port a3 of the BTMS 61 and the second exhaust port Q2 of the vehicle body cover 32.

The second rectifying plate 84 is disposed above one end of the first rectifying plate 83. The second rectifying plate 84 is formed as a plate. The second rectifying plate 84 has a second rectifying surface 84a. The second rectifying surface 84a is oriented toward the left.

As illustrated in FIG. 6, the first rectifying plate 83 is disposed between the discharge port a3 of the BTMS 61 and the second exhaust port Q2 of the vehicle body cover 32 as seen in a top view. The first rectifying plate 83 covers the bottom of a gap space between the discharge port a3 of the BTMS 61 and the second exhaust port Q2 of the vehicle body cover 32. Consequently, warm air discharged from the discharge port a3 of the BTMS 61 can be suppressed from returning to the inside of the second region S2. When a gap is present between the vehicle body cover 32 and the second partition plate 36, the warm air discharged from the discharge port a3 of the BTMS 61 can be suppressed from flowing into the first region S1. The first rectifying plate 83 may cover only a portion of the gap space or may cover all of the gap space.

As illustrated in FIG. 6, the second rectifying plate 84 is disposed between the discharge port a3 of the BTMS 61 and the second exhaust port Q2 of the vehicle body cover 32 as seen in a top view. The second rectifying plate 84 covers the side (the right side in the example illustrated in FIG. 6) of the gap space between the discharge port a3 of the BTMS 61 and the second exhaust port Q2 of the vehicle body cover 32. Consequently, warm air discharged from the discharge port a3 of the BTMS 61 can be suppressed from returning to the inside of the second region S2. The second rectifying plate 84 may cover only a portion of the side of the gap space or may cover all of the gap space.

1. A work machine configured to actuate a work implement with power from a battery device, the work machine comprising:
a first region in which the battery device is disposed;
a second region in which a battery thermal management system is disposed, the battery thermal management system being configured to manage temperature of the battery device; and
a vehicle body cover having a polyhedral shape and surrounding the first region and the second region,
in the vehicle body cover, an orientation of a surface in which a first air intake port arranged to guide air into the first region is formed, is different from an orientation of a surface in which a second exhaust port arranged to draw air out from the second region is formed.

2. The work machine according to claim 1, wherein
in the vehicle body cover, an orientation of a surface in which a first exhaust port arranged to draw air out from the first region is formed, is different from an orientation of a surface in which a second air intake port arranged to guide air into the second region is formed.

3. The work machine according to claim 1, wherein
in the vehicle body cover, the surface in which the first air intake port is formed is positioned on an opposite side from the surface in which the second exhaust port is formed.

4. The work machine according to claim 1, further comprising:
a cooling unit configured to cool at least one of hydraulic fluid to be supplied to the work implement and refrigerant to be supplied to an air-conditioning device, the cooling unit being disposed in the first region,
the cooling unit being disposed downstream of the battery device along the direction that air inside the first region flows.

5. The work machine according to claim 1, further comprising:
a cab disposed in front of the vehicle body cover,
the surface in which the second exhaust port is formed is a front surface of the vehicle body cover, and
at least a portion of the second exhaust port is spaced away from the cab as seen in a front view.

6. The work machine according to claim 1, further comprising:
an electric motor configured to be driven with power from the battery device,
a third region in which a hydraulic pump driven by the electric motor is disposed, and
a first partition plate configured to partition the first region and the third region.

7. The work machine according to claim 1, further comprising:
a second partition plate configured to partition the first region and the second region.

8. The work machine according to claim 1, further comprising:
a rectifying member,
the battery thermal management system having a discharge port arranged to discharge air, and
the rectifying member being configured to guide air discharged from the discharge port of the battery thermal management system to the second exhaust port of the vehicle body cover.
